(19) United States
(12) Patent Application Publication
(10) Pub. No.: US 2002/0198715 A1
(43) Pub. Date: Dec. 26, 2002

(54) Artificial language generation

(75) Inventor: Guillaume Belrose, South Bristol (GB)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/166,256

(22) Filed: Jun. 11, 2002

(30) Foreign Application Priority Data
Jun. 12, 2001 (GB) 0114236.3

(51) Int. Cl. G10L 13/06

(52) U.S. Cl. 704/266

(57) ABSTRACT

A method is provided of generating an artificial language for use, for example, in human speech interfaces to devices. The language generation method involves using a genetic algorithm to evolve a population of individuals over a plurality of generations, the individuals forming or being used to form candidate artificial-language words. These words are evaluated against a predetermined fitness function with the results of this evaluation being used to select individuals to be evolved to form the next generation of the population. To produce languages suitable for human speech interfaces to devices, the fitness function preferably takes account both of correct recognition of candidate words when spoken to a speech recognition system, and the similarity of candidate words to words in a set of user-favourite words.

### FIELD OF THE INVENTION

The present invention relates to the generation and evaluation of artificial languages and, in particular but not exclusively, to the generation and evaluation of artificial languages for facilitating the automated recognition of speech.

### BACKGROUND OF THE INVENTION

The new driver of mobility and appliance computing is creating a strong business pull for efficient human computer interfaces. In this context, speech interfaces have many potential attractions such as naturalness and hands-free operation. However, despite 40 years of spoken language systems work, it has proved very hard to train a computer in a human language so that it can have a dialogue with a human. Even the most advanced spoken language systems in the best research groups in the world still suffer the same inadequacies and problems as less advanced speech systems, namely, high set up cost, low efficiency and small domains of discourse.

The present invention concerns an approach to improving speech interfaces that involves the use of artificial language(s) to facilitate automated speech recognition.

Of course, all language is man-made, but artificial languages are made systematically for some particular purpose. They take many forms, from mere adaptations of an existing writing system (numerals), through completely new notations (sign language), to fully expressive systems of speech devised for fun (Tolkien) or secrecy (Poto and Cabenga) or learnability (Esperanto).There have also been artificial languages produced of no value at all such as Dilingo and even artificial language toolkits.

Esperanto, which is probably the best known artificial language, was invented by Dr. Ludwig L. Zamenhof of Poland, and was first presented to the public in 1887. Esperanto has enjoyed some recognition as an international language, being used, for example, at international meetings and conferences. The vocabulary of Esperanto is formed by adding various affixes to individual roots and is derived chiefly from Latin, Greek, the Romance languages, and the Germanic languages. The grammar is based on that of European languages but is greatly simplified and regular. Esperanto has a phonetic spelling. It uses the symbols of the Roman alphabet, each one standing for only one sound. A simplified revision of Esperanto is Ido, short for Esperandido. Ido was introduced in 1907 by the French philosopher Louis Couturat, but it failed to replace Esperanto.

None of the foregoing artificial languages is adapted for automated speech recognition.

Our co-pending UK Patent Application No. 0031450.0 (Dec. 22, 2000) describes a class of artificial spoken languages that can be easily understood by automated speech recognizers associated with equipment, such languages being intended to be learnt by human users in order to speak to the equipment. These spoken languages are hereinafter referred to as “Computer Pidgin Languages” or “CPLs”, because like Pidgin languages in general, they are simplified in terms of vocabulary and structure. However, unlike normal human pidgin languages, the CPLs are languages specifically designed to minimize recognition errors by automated speech recognizers. In particular, a CPL language is made up of phonemes or other uttered elements that, at least in combination, are not easily confused with each other by a speech recognizer, the uttered elements being preferably chosen from an existing language.

In the above-referenced UK Patent Application a basic method is described for generating new CPLs. It is an object of the present invention to provide improved methods of generating CPLs and evaluating their worth.

### SUMMARY OF THE INVENTION

According to the present invention there is provided a method of generating an artificial language, wherein a genetic algorithm is used to evolve a population of individuals over a plurality of generations, the individuals forming or being used to form candidate artificial-language words which are evaluated against a predetermined fitness function with the results of this evaluation being used by the genetic algorithm to select individuals to be evolved to form the next generation of the population.

Advantageously, the individuals of the population are:

candidate artificial-language words; or

recipes for forming respective vocabularies of candidate artificial-language words; or

vocabularies of candidate artificial-language words.

Preferably, the fitness function comprises a combination of:

a measure of the ease of correct recognition of a candidate artificial-language word when spoken to a speech recognition system; and

a measure of the similarity of a candidate artificial-language word to any constituent word of a set of reference words as measured by a speech recognition system to which said word is spoken.

According to another aspect of the present invention, there is provided apparatus for generating an artificial language, comprising:

storage means for storing a population of individuals, and

genetic-algorithm processing means comprising:

providing means for providing candidate artificial-language words from the individuals of the population stored in the storage means;

evaluation means for evaluating the candidate artificial-language words using a predetermined fitness function;

evolution means, responsive to the evaluation carried out by the evaluation means, to select individuals from said population and to use them in forming a next generation of the population that is then stored back in the storage means; and

control means for controlling operation of the processing means to evolve the population of individuals over a plurality of generations.

### BRIEF DESCRIPTION OF THE DRAWINGS

Embodiments of the invention will now be described, by way of non-limiting example, with reference to the accompanying diagrammatic drawings, in which:

FIG. 1 is a diagram illustrating a system for creating a new CPL according to a process described in the above-referenced patent application;

FIG. 2 is a diagram illustrating an arrangement for testing the fitness of candidate CPL words;

FIG. 3 is a diagram illustrating a first process for generating a new CPL using a genetic algorithm approach; and

FIG. 4 is a diagram illustrating a second process for generating a new CPL, also using a genetic algorithm approach.

### BEST MODE OF CARRYING OUT THE INVENTION

As already indicated, the present invention concerns the creation and evaluation of spoken artificial languages (CPLs) that are adapted to be recognised by speech recognisers. A new CPL can be created as required, for example, for use with a new class of device.

In our above-referenced co-pending Application, a method of creating a new CPL is described that involves following the simple rules set out below:

1. Pick a subset of phonemes from a specific human language (such as English or Esperanto) that are not easily confused one with another by an automated speech recognition, and are easily recognized. This subset may exhibit a dependency on the speech recognition technology being used; however, since there is generally a large overlap between the subsets of easily recognized phonemes established with different recognition technologies, it is generally possible to choose a subset of phonemes from this overlap area. It should also be noted that the chosen phoneme subset need not be made up of phonemes all coming from the same human language, this being done simply to make the subset familiar to a particular group of human users.

2. Make words up that are easily recognized and distinguished using the phonemes from the subset chosen in (1). The constructed words are, for example, structured as CVC (Consonant Vowel Consonant) like Japanese as this structure is believed to perform best in terms of recognition. Other word structures, such as “CV”, are also possible.

3. Pick a filler sound that allows word boundaries to be easily distinguished (this step is optional, particularly where words are intended only to be used individually since silence then constitutes an effective filler).

4. Pick a simple grammar structure with very little ambiguity (again, this step is optional in the sense that where a CPL is based on single word commands, no grammar is required—other than that the command words are to be taken individually).

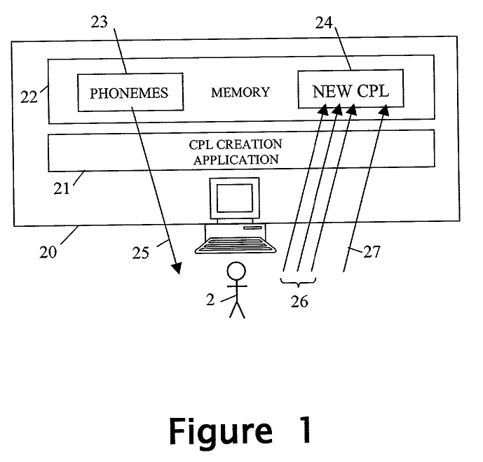

As described in the above-referenced Application, in order to select a low-confusion-risk phoneme subset, a phone confusion matrix can be produced for a particular speech recognizer by comparing the input and output of the recognizer over a number of samples. This matrix indicates for each phone the degree of correlation with all the other phones. In other words, this matrix indicates the likelihood of a phone being mistaken for another during the recognition process. An example confusion matrix produced from a British English corpus forms FIG. 1 of the above-referenced Application. By examining the matrix, it is readily possible to ascertain which pairings of phonemes should be avoided if confusion is not to result.

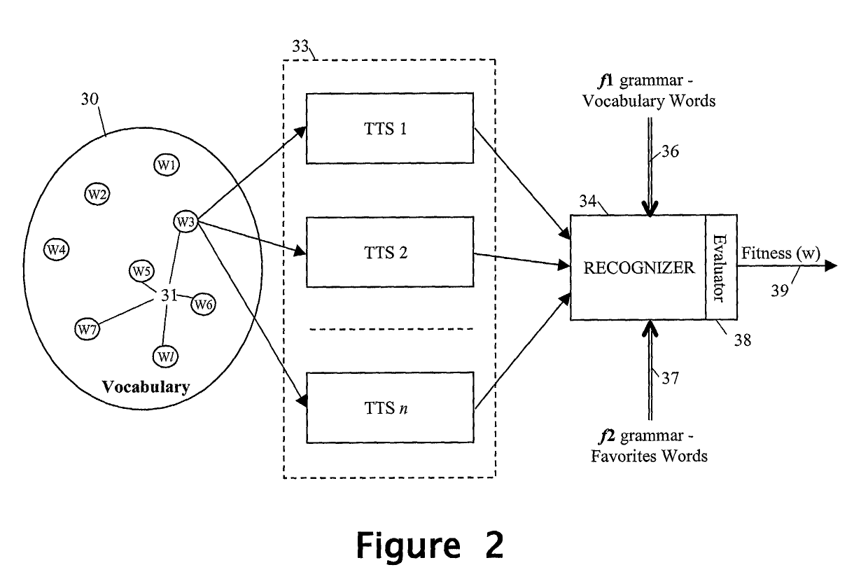

FIG. 1 of the accompanying drawings (which also forms FIG. 2 of the above-referenced application) illustrates a system 20 by which a user 2 can generate a new CPL according to the process described above. The system 20 is based on a computer running a CPL creation application 21 and storing in memory 22 the low-confusion-risk phoneme subset 23 for a language base (such as British English) selected by the user. This phoneme subset is presented to the user 2 (see arrow 25) who then uses the phonemes as building blocks for constructing new words which are stored back to memory (see arrows 26) as part of the new CPL 24. The user can also specify a grammar for the new CPL, this grammar being stored (see arrow 27) as part of the CPL. The system is also arranged to test out the chosen words for ease of recognition and lack of confusion on a target speech recognizer, the results of this test being fed back to the user; this testing can either be done automatically (for example, whenever a new word is stored) or simply upon user request. Whilst the human meaning associated with a CPL word is likely to be attributed at this stage (the CPL word may suggest this meaning in the base language), this is not essential.

Whilst the above process and system for generating a CPL is capable of producing useful results, it is not well adapted to produce really efficient CPLs or to take account of criteria additional to low-confusion and ease of recognition.

As will be described below, the present invention provides fitness measures of candidate CPL words, and automated processes for CPL generation based on the use of genetic algorithm (GA) techniques.

### FITNESS MEASURES

The GA-based CPL generation methods to be described both involve the application of a fitness function to candidate CPL words in order to select individuals to be evolved. In the present case, the fitness function is combination of a first fitness measured f1 concerning a first criteria (criteria 1) that candidate CPL word should be easy to recognize correctly by an automatic speech recognizer (ASR) system, and a second fitness measure f2 concerning a second criteria (criteria 2) that the word should be easy for a human to learn and remember.

FIG. 2 depicts the general process involved in evaluating both the first and second fitness measures. To evaluate a word 31 from a vocabulary 30 of L words (W1 to Wl), the word is spoken to an ASR system 34 and a fitness measure is produced by evaluator 38 on output 39 according to fitness measured f1 or f2. Whilst the word being evaluated could in theory be spoken by a human to the ASR system 34, practicality requires that a text-to-speech (TTS) system 33 is used, here shown as composed of n TTS engines TTS1-TTSn for reasons which will become apparent below.

### First Fitness Measure

More particularly, in evaluating the first fitness measure f1 (how well a word is recognized), the ASR system 34 is installed with a speech grammar setting the ASR system to recognise all the L words from the vocabulary 30 (arrow 36). Thus, typically, the grammar takes the form:

Sentence=word1|word2|word3|. . . |wordl;

Word1 =“blurp”;

Wordn=“kligon”;

The evaluator 38, in applying the first fitness measure, takes account of whether or not a word is correctly recognised and the confidence score associated with recognition (the confidence score being generated by the ASR system 34 and, in the present example, being assumed to be in the range of −100 to +100 as provided by the Microsoft Speech API). More specifically, for a given word w, the first fitness measure f1(w)evaluates as follows:

rec1(w): 1 if the recognizer recognises w when the input is actually w, 0 otherwise;

score1(w): the confidence score attributed to this word by the ASR system.

f1(w)=rec1(w)*(100+score1(w))

This evaluation is effected by evaluator 38. Where multiple TTS engines are provided, for each word each engine speaks the word in turn and the evaluator 38 combines the resultant measures produces for each engine to provide an overall first fitness measure for the word concerned.

### Second Fitness Measure

The second fitness measure f2 evaluates how easy a word is to learn and to remember by the user. This notion is quite difficult to assess and in the present case is based on the premise that it will easier for a user to learn and use words that sound familiar to him. Such words are captured by having the user set up a list of the words he likes to hear (called “favorites”); alternatively, a core of common real words can be used for this list (for example, if the user does not want to take the time to specify a personal favorites list). The fitness measures f2 evaluates how similar a CPL word is to any word from the favorites list. To measure this similarity, the ASR system 34 is installed with a grammar that can recognize any words from the favorites list (arrow 37). The ASR system is then used to try to recognise words from the vocabulary 30. For a given word w, the second fitness measure f2 (w) evaluates as follows:

rec2(w): 1 if the ASR recognized any word from favorites while listening to w, 0 otherwise.

score2(w): the confidence score.

f2(w)=rec2(w)*(100+score2(w))

For a word w, the higher f2 (w), the more similar w is to a word from the favorites list (no matter which one). For example

favorites={boom, cool, table, mouse}

f2(“able”)=100 (was mistaken for “table”)

f2(“spouse”)=60 (was mistaken for mouse)

f2(“bool”)=81 (was mistaken for cool)

f2(“smooth”)=46 (was mistaken for boom)

f2(“steve”)=0

f2(“Robert”)=0

f2(“paul”)=34 (was mistaken for cool)

### Combining the Measures

The first and second fitness measures are combined, for example, by giving each a weight and adding them. The weighting is chosen to give, for instance, more importance to f1 than to f2.

### Introducing Additional Factors

It is possible to cause the fitness measures to take account of certain potentially desirable characteristics by appropriately setting up the evaluation channel (TTS system to ASR system). For example, in order to provide a CPL vocabulary that is speaker-gender independent, multiple TTS engines are provided (as illustrated) corresponding to different genders with the result that the fitness measures will reflect performance for all genders. Similarly:

Acoustic independence can be included as a factor by testing the spoken words with multiple ASR engines corresponding to different acoustic models;

Robustness to noise can be included as a factor by introducing some noise into the spoken version of words.

### GENERATION OF THE CPL VOCABULARY

Two GA-based methods for generating CPL words will now be described, both these methods employing the above-described fitness function combining the first and second fitness measures.

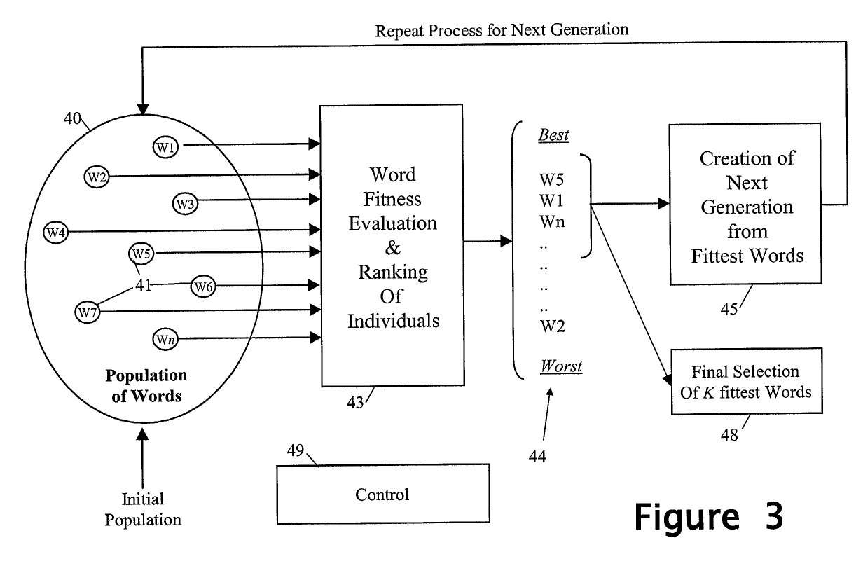

### Word Coding Population (FIG. 3)

In this CPL generation method, a population 40 is composed of individuals 41 that each constitute a candidate CPL word W1-Wl. Each individual is coded as a character string (the “DNA” of the individual), for example:

DNA(W1)=“printer”,

DNA(W2)=“switch off”.

A word is coded using a maximum of p letters chosen from the alphabet. There are 27ˆ p possible combinations (26+the * wild card letter, standing for no letter). The initial set of words is made of L words from a vocabulary of English words (i.e. “print”, “reboot”, “crash”, “windows”, etc.) where L>K, K being the required number of words in the target CPL vocabulary to be generated.

Starting with the initial population, the fitness of the individual words 41 of the population 40 is evaluated using the above-described fitness function (weighted measures f1 and f2) and the individual words ranked (process 43 in FIG. 3) to produce ranking 44. The fittest individuals are then selected and used to create the next generation of the population, by applying genetic operations by mutation and/or cross-over and/or reproduction (box 45). Mutation consists of changing one or more letters in the DNA of a word, for example:

DNA=“printer”→“crinter”.

Cross-over consists of exchanging fragments of DNA between individuals, for instance:

“Printer”“Telephone”→“Prinphone”“Teleter”.

The application of these genetic operators is intended to result in the creation of better individuals by exchanging features from individuals that have a good fitness.

The foregoing process is then repeated for the newly generated population, this cycle being carried either a predetermined number of times or until the overall fitness of successive populations stabilizes. Finally, the K best individuals (words) are selected from the last population (block 48) in order to form the CPL vocabulary. The overall process is controlled by control block 49.

The above CPL generation method can be effected without placing any constraints on the form of the words generated by the block 45; however, it is also possible, and potentially desirable, to place certain constraints on word form such as, for example, that consonants and vowels must alternate.

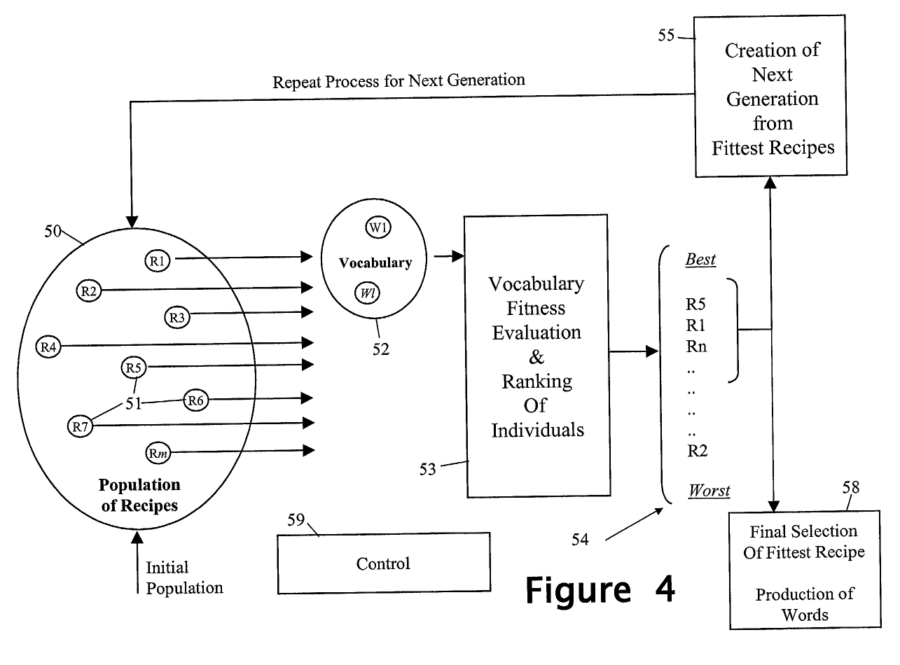

### Vocabulary Coding Population (FIG. 4)

In this CPL generation method, a population 50 is composed of m individuals 51 that each constitute a recipe for generating a respective vocabulary of candidate CPL words. The parameters of a recipe are, for example,:

Format of the words that can be created

Example: C V Any-Letter C V

where C=consonant and V=vowel

set of vowels available for use in word generation

set of consonant available for use in word generation with an example individual being:

| | |
|---|---|
| Format | = C V Any-Letter C V |
| C set | = {b, c, d, f, h, k, l, p} |
| V set | = {a, I, o, u} |

This individual could create the words

Balka, coupo, etc. . .

For each generation of the population, each individual 51, that is, each recipe R1-Rm, is used to randomly generate a respective vocabulary 52 of L words W1-Wl. These words are then each evaluated (block 53) using the above-described fitness function (weighted measures f1, f2) and an average score produced for all words in the vocabulary 52. This score is taken as a measure of the fitness of the recipe concerned and is used to rank the recipes into ranking 54. The fittest recipes are then selected and used to produce the next generation of the recipe population (see block 55) by mutation and/or cross-over and/or reproduction; in other words, these genetic operators are used to changes the parameters of the recipes and produce new ways of creating words. The approach is based on the supposition that after many generations, the best individual recipe will create words with the optimal structure and alphabet; however, by way of a check, the fittest individual in each generation is stored and its fitness compared with that of the fittess individual of the at least the next generation, the fittest individual always being retained. The fittest individual produced at the end of the multiple-generation evolution process is then selected and used (block 58) to produce a vocabulary of size L from which the fittest K words are selected. The overall process is controlled by control block 59.

In a first version of this method, word format is represented by a single parameter, the DNA of an individual taking the form of a sequence of bits that codes this parameter and parameters for specifying the consonant and vowel sets of the recipe, for example:

00 01 10 11 00 11100011100110011000110 110111

Here, the first 12 bits code the structure of words that can be generated:

00→no character

01→consonant

10→vowel

11→any letter

00→no character

The next 22 bits code the consonant set with a bit value of “1” at position i indicating that the consonant at position i in a list of alphabet consonants is available for use in creating words. The remaining 6 bits code the vowel set in the same manner; for example the bit sequence ” 011011 ” codes the vowel set of {e, i, u, y}.

Examples of words that can be created according to the above example are:

ora y, aje h

In a second version of this method, each word is made up of a sequence of units each of which has a fixed form. A unit can for example, be a letter, a CV combination, a VC combination, etc. To represent this, each recipe has one parameter for the unit form and a second parameter for the number of units in a word; the recipe also includes, as before, parameters for coding the consonant and vowel sets. In this version of the method, the recipe DNA is still represented as a sequence of bits, for example:

10 110 100110011100111011110 001100

The first 2 bits indicate the form of each unit

10 →VC unit

The next 3 bits code the number of units per word

110 →6:6/2+1=4 units per word.

The next 22 bits code the consonants set whilst the final 6 bits code the vowels set.

Example of words created by this example recipe are:

obobifiy, okilimox

### USAGES

Example usages of a CPL are given below

CPL Speed dialing—CPL contact names.

A mobile phone contains a list of contact names and telephone numbers. Each name from this list can be transformed into a CPL version (CPL nickname) by setting these names as favorites during the CPL generation process. A speech recognizer in the mobile phone is set to recognize the nicknames. In use, when a user wishes to contact a person on the contact names list, the user speaks the nickname to initiate dialing. To assist the user in using the correct nickname, the contact list including both real names and nicknames can be displayed on a display of the phone. By way of example, for a list containing the three names Robert, Steve and Guillaume, three CPL nicknames are created: Roste, Guive, Yomer. They appear on the phone screen as:

| | |
|---|---|
| Roste | (Robert) |
| Guive | (Steve) |
| Yomer | (Guillaume) |

CPL to SMS transcriber.

In this case, a mobile phone or other text-messaging device is provided with a speech recognizer for recognizing the words of a CPL. The words of the CPL are assigned to commonly used expressions either by default or by user input. In order to generate a text message, the user can input any of these expressions by speaking the corresponding CPL word, the speech recognizer recognizing the CPL word and causing the corresponding expression character string to be input into the message An being generated. Typical expressions that might be represented by CPL words are “Happy Birthday” or “See you later.”

It will be appreciated that usage of a CPL generated by the methods described herein will generally involve conditioning a speech recogniser to recognise the CPL words by loading the CPL vocabulary into the recogniser and/or training the recogniser on the CPL words. Furthermore, the generated CPL (and/or selected ones of the final generation of individuals) can be distributed to users by any suitable method such as by storing a representation of the CPL words on a transferable storage medium for distribution.

### VARIANTS

It will be appreciated that many variants are possible to the above described embodiments of the invention. For example, the individuals of a population to be evolved could be constituted by respective vocabularies each of L candidate CPL words, the initial words for each vocabulary being, for instance, chosen at random (subject, possibly, to a predetermined word format requirement). At each generation, the fitness of each vocabulary of the population is measured in substantially the same manner as for the vocabulary 52 of the FIG. 4 embodiment. The least-fit vocabularies are then discarded and new ones generated from the remaining ones by any appropriate combination of genetic operations (for example, copying of the fittest vocabulary followed by mutation and cross-over of the component words). The constituent words of the retained vocabularies may also be subject to genetic operations internally or across vocabularies. This process of fitness evaluation, selection and creation of a new generation, is carried out over multiples cycles and the fittest K words of the fittest vocabulary are then used to form the target CPL vocabulary.

In order to speed the creation of a vocabulary with user-friendly words, the words on the favorites list can be used as the initial population of the FIG. 3 embodiment, or in the case of the embodiment described in the preceding paragraph, as at least some of the component words of at least some of the initial vocabularies. As regards the FIG. 4 embodiment, the constituent consonants and vowels of the words on the favorites list can be used as the initial consonant and vowel sets of the recipes forming the individuals of the initial population.

Whilst the fitness function (weighted measures f1, f2) in the described embodiments has been used to favour CPL words giving both good speech recogniser performance and user-friendliness (that is, they sound familiar to a user), the fitness function could be restricted to one of f1 and) f2 to select words having the corresponding characteristic, with the other characteristic then being bred into words by tailoring the subsequent genetic operations for appropriately generating the next-generation population. Thus, if the fitness function was set to measure f1, it is possible to bias the generation of CPL words towards user-friendly words by making the application of genetic operations, during the creation of the next generation of individuals, in a manner that favours the creation of such words; this can be achieved, for example, in the application of the cross-over operations, by giving preference to new individuals that possess, or are more likely to generate, phoneme combinations that are user-preferred (such as represented by words on a favorites list) or like-sounding phoneme combinations. Similarly, mutation can be effected in a manner tending to favour user-preferred phoneme or phoneme combinations or like-sounding phoneme or phoneme combinations. As already indicated, it is alternatively possible to arrange for the fitness function to be restricted to f2 and then apply the genetic operators in a manner favouring the generation of CPL words that are easy to recognise (that is, have a low confusion risk as indicated, for example, by a confusion matrix derived for the recognizer concerned). In fact, although not preferred, the genetic operators can be applied such s to favour the generation of CPL words that are both easy to recognise automatically and are user-friendly thereby removing the need to use the fitness function to select for either of these characteristics; a further alternative would be to do both this and to effect selection based on a fitness function involving both f1 and f2.

Another approach to generating words that are both easy to recognise automatically and have a familiarity to a user is simply to alternate the fitness function between f1 and f2 in successive generation cycles.

Whilst the evaluation method described above with reference to FIG. 2 is preferred for effecting measures of ease of recognition and user friendliness of words, other ways of making these measures are also possible. For example, the evaluation of words in terms of how easily they are correctly recognised by a speech recognition system can be effected by analysis of the phoneme composition of the words in relation to a confusion matrix established for a target speech recognition system. As regards the evaluation of words in terms of a familiarity to a human user, this can be effected by analysis of the phoneme composition of the words in relation to that of a set of reference words familiar to a user.

Another possible variant is to select the fitness function so as to directly take account of additional or different fitness criteria, this being in addition to the possibility, discussed above, of introducing factors, such as gender of voice, into the evaluation of f1 and/or f2. The use of the described GA-based methods of artificial language generation are therefore not restricted to languages optimised for automatic recognition.

1. A method of generating an artificial language, wherein a genetic algorithm is used to evolve a population of individuals over a plurality of generations, the individuals forming or being used to form candidate artificial-language words which are evaluated using a predetermined fitness function with the results of this evaluation being used by the genetic algorithm to select individuals to be evolved to form the next generation of the population.

2. A method according to claim 1, wherein said individuals are candidate artificial-language words, the fittest words of each generation being used to produce the words of the next generation by a process involving at least one of mutation and cross-over.

3. A method according to claim 2, wherein the production of next-generation words is constrained to cause each such word to have a format in which each constituent consonant or vowel, unless terminating the word, is respectively followed by a vowel or consonant.

4. A method according to claim 2, wherein each generation of said population is made up L individuals, the method including a final step of selecting the K fittest words of the last generation of the population to form the vocabulary of the artificial language, L being greater than K.

5. A method according to claim 1, Wherein said individuals are recipes for forming respective vocabularies of candidate artificial-language words, the method involving at each generation:
using each individual to form a respective vocabulary the constituent words of which are evaluated using said predetermined fitness function; and
forming from the evaluations of the words in an individual's vocabulary, an evaluation of the fitness of the individual; and
using the fittest recipes of each generation to produce the recipes of the next generation by a process involving at least one of mutation and cross-over.

6. A method according to claim 5, wherein each recipe specifies a word format, and a set of consonants and a set of vowels available for use in word generation according to said format.

7. A method according to claim 6, wherein said word format comprises a specified unit form and a specified number of units, said units being formed from the available consonants and vowels according to the specified unit form.

8. A method according to claim 5, wherein the fittest recipe or recipes of each generation are stored for subsequent comparison with those of at least the next generation.

9. A method according to claim 13 wherein said individuals are respective vocabularies of candidate artificial-language words, the fitness of the words in a said vocabulary being evaluated and used to form an overall fitness measure for that vocabulary, this measure then being used as a basis for selecting which vocabularies are to be evolved to form the next generation of the population.

10. A method according to claim 9, wherein the next generation is formed by replacing at least the least fit vocabulary with a vocabulary derived from at least one of the retained vocabularies.

11. A method according to claim 10, wherein at least some of the words of the retained vocabularies are subject to evolution by genetic operations with other words from the same or different vocabularies.

12. A method according to claim 1, wherein said fitness function comprises a measure of the ease of correct recognition of a candidate artificial-language word when spoken to a speech recognition system.

13. A method according to claim 12, wherein the candidate artificial-language words are spoken to the speech recognition system by multiple text-to-speech converters in turn, the fitness measure made in respect of any particular word being a combination of the measures made for the speaking of the word by each converter.

14. A method according to claim 12, wherein the candidate artificial-language words are spoken by a text-to-speech conversion system to the speech recogniser system, the channel involving these systems being implemented in a manner such that said fitness measure takes account of at least one desired operational characteristic.

15. A method according to claim 1, wherein said fitness function comprises a measure of the similarity of a candidate artificial-language word to any constituent word of a set of reference words as measured by a speech recognition system to which said word is spoken.

16. A method according to claim 15, wherein the candidate artificial-language words are spoken to the speech recognition system by multiple text-to-speech converters in turn, the fitness measure made in respect of any particular word being a combination of the measures made for the speaking of the word by each converter.

17. A method according to claim 15, wherein the candidate artificial-language words are spoken by a text-to-speech conversion system to the speech recogniser system, the channel involving these systems being implemented in a manner such that said fitness measure takes account of at least one desired operational characteristic.

18. A method according to claim 1, wherein said fitness function comprises a combination of:
a measure of the ease of correct recognition of a candidate artificial-language word when spoken to a speech recognition system; and
a measure of the similarity of a candidate artificial-language word to any constituent word of a set of reference words as measured by a speech recognition system to which said word is spoken.

19. A method according to claim 18, wherein the candidate artificial-language words are spoken to the speech recognition system by multiple text-to-speech converters in turn, the fitness measure made in respect of any particular word being a combination of the measures made for the speaking of the word by each converter.

20. A method according to claim 18, wherein the candidate artificial-language words are spoken by a text-to-speech conversion system to the speech recogniser system, the channel involving these systems being implemented in a manner such that said fitness measure takes account of at least one desired operational characteristic.

21. A method according to claim 20, wherein said at least one desired operational characteristic is at least one of:
gender independence, for which purpose the text-to-speech system is provided with multiple text-to-speech converters corresponding to different genders to generate spoken versions of the words;
acoustic independence, for which purpose the speech recognizer system is provided with multiple speech recognizers corresponding to different acoustic models;
robustness to noise, for which purpose noise is introduced into the channel.

22. A method according to claim 1, wherein the evolution of the individuals selected to form the next generation is effected in a manner favouring the creation of candidate artificial-language words having a desired characteristic.

23. A method according to claim 22, wherein said desired characteristic is ease of recognition by an automatic speech recognizer

24. A method according to claim 22, wherein said desired characteristic is similarity to natural language words.

25. A method according to claim 1, wherein at least selected ones of the final generation of individuals are stored on a transferable storage medium.

26. A method according to claim 1, wherein the final generation of individuals is used to provide words of said artificial language and representations of these words are stored on a transferable storage medium.

27. A method of conditioning a speech recogniser, comprising the steps of:
generating words of an artificial language using a method according to claim 1, and
loading the generated artificial-language words into a lexicon of the speech recogniser.

28. A method of conditioning a speech recogniser, comprising the steps of:
generating words of an artificial language using a method according to claim 1, and
training the speech recogniser to recognise the generated artificial-language words.

29. Apparatus for generating an artificial language, comprising:
storage means for storing a population of individuals, and
genetic-algorithm processing means comprising:
providing means for providing candidate artificial-language words from the individuals of the population stored in the storage means;
evaluation means for evaluating the candidate artificial-language words using a predetermined fitness function;
evolution means, responsive to the evaluation carried out by the evaluation means, to select individuals from said population and to use them in forming a next generation of the population that is then stored back in the storage means; and
control means for controlling operation of the processing means to evolve the population of individuals over a plurality of generations.

30. Apparatus according to claim 29, wherein said individuals are candidate artificial-language words, the evolution means being operative to use the fittest words of each generation to produce the words of the next generation by a process involving at least one of mutation and cross-over.

31. Apparatus according to claim 30, wherein the evolution means is constrained to cause each next-generation word to have a format in which each constituent consonant or vowel, unless terminating the word, is respectively followed by a vowel or consonant.

32. Apparatus according to claim 30, wherein each generation of said population is made up L individuals, the apparatus further comprising means operative to select the K fittest words of the last generation of the population to form the vocabulary of said artificial language, L being greater than K.

33. Apparatus according to claim 29, wherein said individuals are recipes for forming respective vocabularies of candidate artificial-language words, and wherein at each generation:
the said providing means is operative to use each recipe to form a respective vocabulary;
the said evaluation means is operative to use said predetermined fitness function to evaluate the constituent words of each vocabulary formed by the providing means and to use the evaluations of the words in each said vocabulary to produce an evaluation of the fitness of the corresponding recipe; and
the evolution means is operative to use the fittest recipes of each generation to produce the recipes of the next generation by a process involving at least one of mutation and cross-over.

34. Apparatus according to claim 33, wherein each recipe specifies a word format, and a set of consonants and a set of vowels available for use in word generation according to said format.

35. Apparatus according to claim 34, wherein said word format comprises a specified unit form and a specified number of units, said units being formed from the available consonants and vowels according to the specified unit form.

36. Apparatus according to claim 33, further comprising comparison means operative to compare the fittest recipe or recipes of each generation with those of at least the next generation.

37. Apparatus according to claim 29, wherein said individuals are respective vocabularies of candidate artificial-language words, the evaluation means being operative to evaluate the fitness of the words in a said vocabulary and, based on these evaluations, to form an overall fitness measure for that vocabulary; the evolution means being operative to use this fitness measure of each vocabulary as a basis for selecting which vocabularies are to be evolved to form the next generation of the population.

38. Apparatus according to claim 31, wherein the evolution means is operative to form the next generation by replacing at least the least fit vocabulary with a vocabulary derived from at least one of the retained vocabularies.

39. Apparatus according to claim 38, wherein the evolution means is operative to evolve at least some of the words of the retained vocabularies by genetic operations with other words from the same or different vocabularies.

40. Apparatus according to claim 29, wherein the evaluation means includes a speech recognition system, the evaluation means being operative to derive and use as at least part of said fitness function, a measure of the ease of correct recognition of a candidate artificial-language word when spoken to said speech recognition system.

41. Apparatus according to claim 29, wherein the evaluation means includes a speech recognition system, the evaluation means being operative to derive and use as at least part of said fitness function, a measure of the similarity of a candidate artificial-language word spoken to said speech recognition system to any constituent word of a set of reference words as measured by said speech recognition system.

42. Apparatus according to claim 29, wherein the evaluation means includes a speech recognition system, the evolution means being operative to derive and use in combination for said fitness function, a combination of:
a measure of the ease of correct recognition of a candidate artificial-language word when spoken to said speech recognition system; and
a measure of the similarity of a candidate artificial-language word spoken to said speech recognition system to any constituent word of a set of reference words as measured by said speech recognition system.

43. Apparatus according to claim 42, wherein the evaluation means further includes multiple text-to-speech converters operative to speak the candidate artificial-language words to the speech recognition system in turn, the fitness measure made in respect of any particular word being a combination of the measures made for the speaking of the word by each converter.

44. Apparatus according to claim 42, wherein the evaluation means further includes a text-to-speech converter system operative to speak the candidate artificial-language words to the speech recogniser system, the channel involving these systems being implemented in a manner such that said fitness measure takes account of at least one desired operational characteristic.

45. Apparatus according to claim 44, wherein said at least one desired operational characteristic is at least one of:
gender independence, for which purpose the text-to-speech system is provided with multiple text-to-speech converters corresponding to different genders to generate spoken versions of the words;
acoustic independence, for which purpose the speech recognizer system is provided with multiple speech recognizers corresponding to different acoustic models;
robustness to noise, for which purpose noise is introduced into the channel.

46. Apparatus according to claim 29, wherein the evolution means is operative to evolve the individuals selected to form the next generation in a manner favouring the creation of candidate artificial-language words having a desired characteristic.

47. Apparatus according to claim 46, wherein said desired characteristic is ease of recognition by an automatic speech recognizer

48. Apparatus according to claim 46, wherein said desired characteristic is similarity to natural language words.

49. A transferable storage medium to which at least selected ones of the final generation of individuals have been stored in accordance with claim 25.

50. A transferable storage medium to which a set of artificial-language words have been stored in accordance with claim 26.

51. A speech recogniser conditioned to recognise artificial-language words according to the method of claim 27.

52. A speech recogniser conditioned to recognise artificial-language words according to the method of claim 28.

53. A set of artificial-language words created by the method of claim 1.
